(19) United States
(12) Patent Application Publication
(10) Pub. No.: US 2014/0380206 A1
(43) Pub. Date: Dec. 25, 2014

(54) METHOD FOR EXECUTING PROGRAMS

(71) Applicants: Paige E. Dickie, King City (CA); Robert G. Dickie, King City (CA)

(72) Inventors: Paige E. Dickie, King City (CA); Robert G. Dickie, King City (CA)

(21) Appl. No.: 13/926,121

(22) Filed: Jun. 25, 2013

(51) Int. Cl. G06F 3/0484; G06F 3/0488

(52) U.S. Cl. CPC G06F 3/0484; G06F 3/0488
USPC 715/762

(57) ABSTRACT

The invention is directed to a method of operating an electronic device having a touchscreen. The device and touchscreen are configured to sense one or more physical gestures made by a user impacting the touchscreen. The gestures are sensed without regard to the location of the gesture input or orientation of the touchscreen. A signal converter converts the impacting physical gesture or combination of gestures into an input signal. If the device recognizes the input signal, the device initiates a function or executes and operation. The user may define a particular gesture combination as well as link gesture combinations with specific functions or operations to execute when the gesture combination is recognized by the device.

### BACKGROUND OF THE INVENTION

1. Technical Field The invention generally relates to operating a computing device. More particularly, the invention relates to a computer configured to identify a series of user inputs on a touchscreen integrated with the computing device. Particularly, the invention relates to sensing a particular series of user inputs on a touchscreen without regard to the location of the inputs or the orientation of the touchscreen, calculating the time intervals therebetween, and executing a particular program based on the particular combination of user inputs and time intervals.

2. Background Information

Many applications (“app” or “apps”) incorporated into mobile computing devices, namely smartphones or tablets, are very useful. Applications are launched when a user engages the screen of the portable computing device in a specific location, often identified by a graphic user interface icon or tile. It has become apparent that it is sometimes inconvenient for a user to look at the smartphone or tablet and select the icon in order to perform a desired function or launch a certain application or program. The present invention addresses this issue and provides an improved way a user may launch an application, program, or function from an electronic device.

### SUMMARY

In one aspect, the invention may provide a method of operating an electronic device having a touchscreen, the method comprising the steps of: defining a first user input selected from a group comprising: one or more taps on the touchscreen, dragging one or more fingers on the touchscreen, timing between sequential touchscreen contact, length of touchscreen contact, and predefined motions made when contacting the touchscreen; programming the electronic device to recognize the first user input without regard to the location of the first user input on the touchscreen and without regard to the orientation of the first user input on the touchscreen; connecting the first user input with an execution call; initiating an operation of the computing device when the execution call is executed; and executing the execution call when the first user input is recognized by the computing device.

In another aspect, the invention may provide a method comprising; receiving a first user input, wherein the first user input is one or more first input points applied to a touch-sensitive display integrated with a computing device; programming the computing device to recognize the first user input without regard to the location of the one or more first input points on the touch-sensitive display; programming the computing device to recognize the first user input without regard to the orientation of the one or more first input points on the touch-sensitive display; creating a first event object in response to the first user input; determining whether the first event object invokes an execution call; and responding to the execution call, if issued, by executing a program associated with the execution call.

In another aspect, the invention may provide a method comprising the steps of: defining a set of functions executable on a computing device; defining a set of gestures recognizable by a touchscreen of the computing device, wherein the gestures are recognized when made on any location of the touchscreen and wherein the gestures are recognized when made in any orientation of the touchscreen; and connecting a first gesture in the set of gestures with a first function in the set of functions; executing the first function when the first gesture is recognized by the touchscreen.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

FIG. 1 is a frontal view of a computer device configured to identify a unique physical gesture or combination of gestures of an operator;

FIG. 2 is a frontal view of the computer device depicting a series of contact points on the touchscreen;

FIG. 3 is a frontal view of the computer device shown at an angle configured to identify the contact points on the touchscreen without regard to angled orientation of the device;

FIG. 4 is a frontal view of the computer device shown at an angle different than FIG. 3 configured to identify the contact points on the touchscreen without regard to angled orientation of the device;

FIG. 5 is a frontal view of the computer device depicting a first impact gesture on a second contact point;

FIG. 6 is a frontal view of the computer device depicting a second impact gesture on a third contact point; FIG. 7 is a frontal view of the computer device third impact gesture on a second contact point;

FIG. 8 is a frontal view of the computer device fourth impact gesture on a third contact point;

FIG. 9 is a frontal view of the computer device initiating a telephone call;

FIG. 10 is a frontal view of a second embodiment of the computer device aligned generally horizontal depicting a first impact gesture on a second contact point;

FIG. 11 is a frontal view of a second embodiment of the computer device aligned generally horizontal depicting a second impact gesture on a third contact point;

FIG. 12 is a frontal view of a second embodiment of the computer device aligned generally horizontal depicting a third impact gesture on a fourth contact point;

FIG. 13 is a frontal view of a second embodiment of the computer device aligned generally horizontal depicting a fourth impact gesture on a third contact point;

FIG. 14 is a frontal view of a second embodiment of the computer device aligned generally horizontal depicting a fifth impact gesture on a second contact point;

FIG. 15 is a frontal view of the computer device initiating an email application;

FIG. 16 is a frontal view of a third embodiment of the computer device aligned generally vertical depicting a first impact gesture simultaneously contact a second and third contact point;

FIG. 17 is a frontal view of a third embodiment of the computer device aligned generally vertical depicting an approaching second gesture;

FIG. 18 is a frontal view of a third embodiment of the computer device aligned generally vertical depicting a third impact gesture simultaneously contact a second and third contact point; and

FIG. 19 is a frontal view of a third embodiment of the computer device aligned generally vertical initiating an internet search engine.

Similar numbers refer to similar parts throughout the drawings.

### DETAILED DESCRIPTION

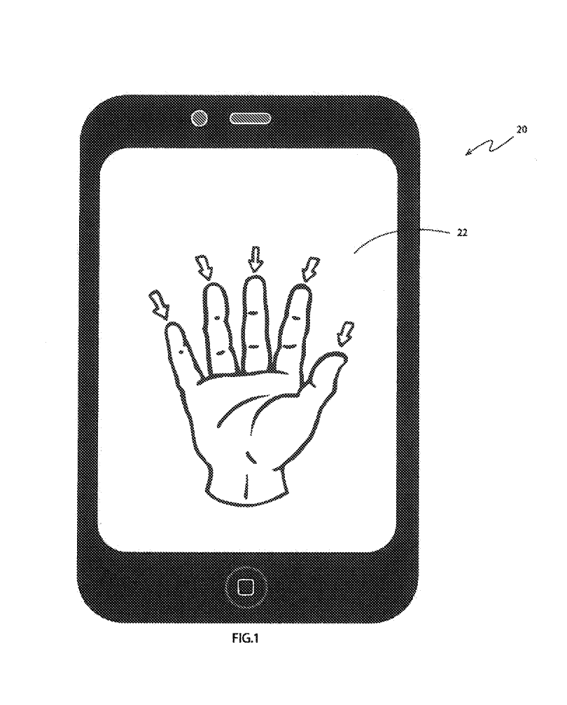

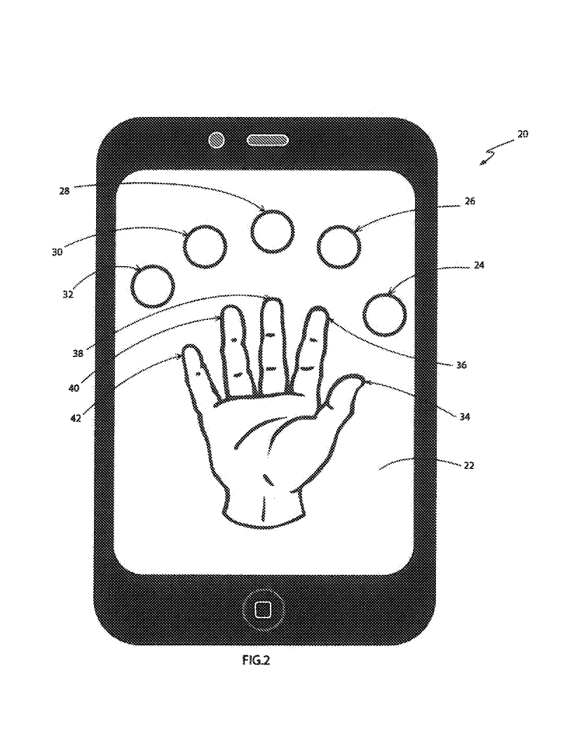

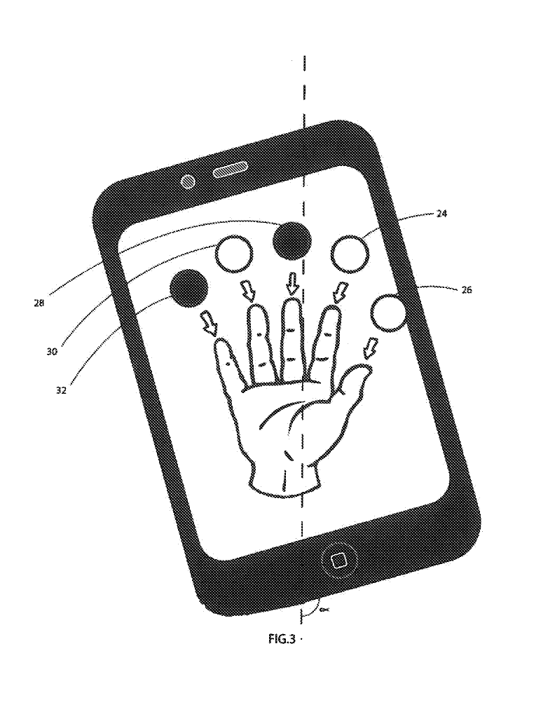

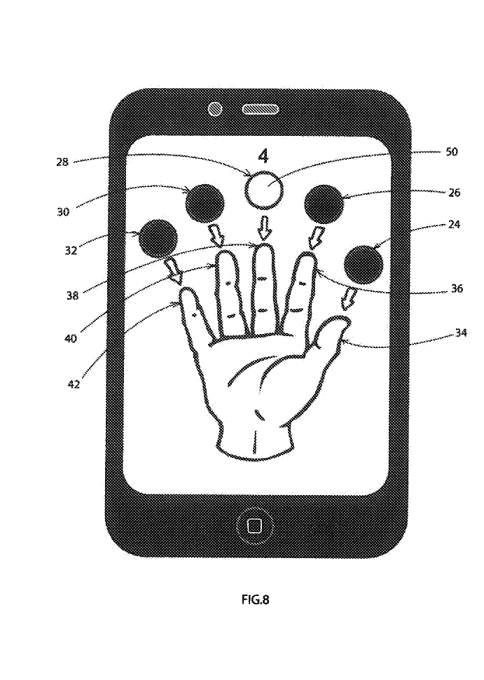

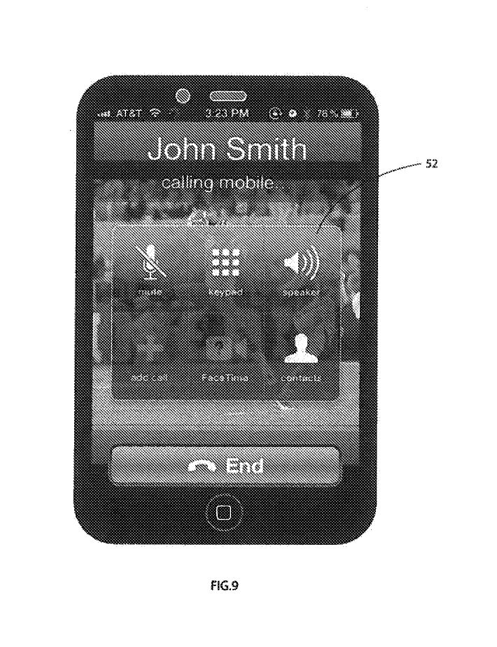

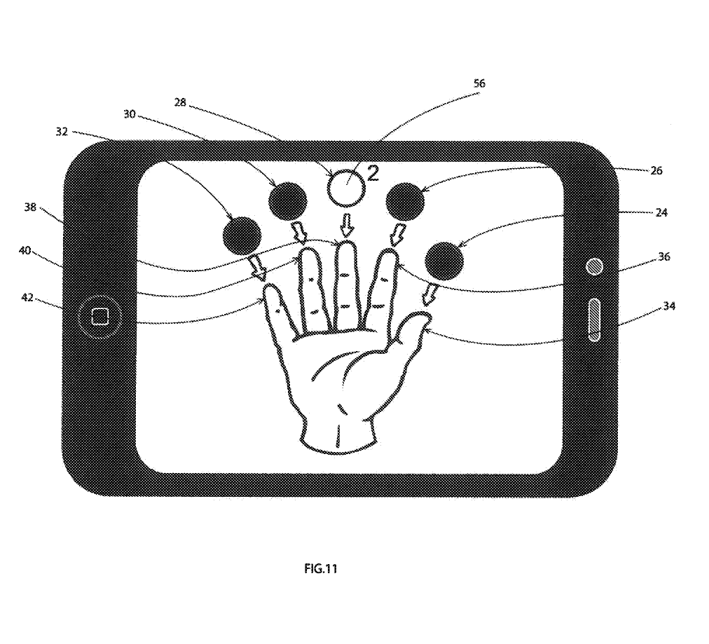

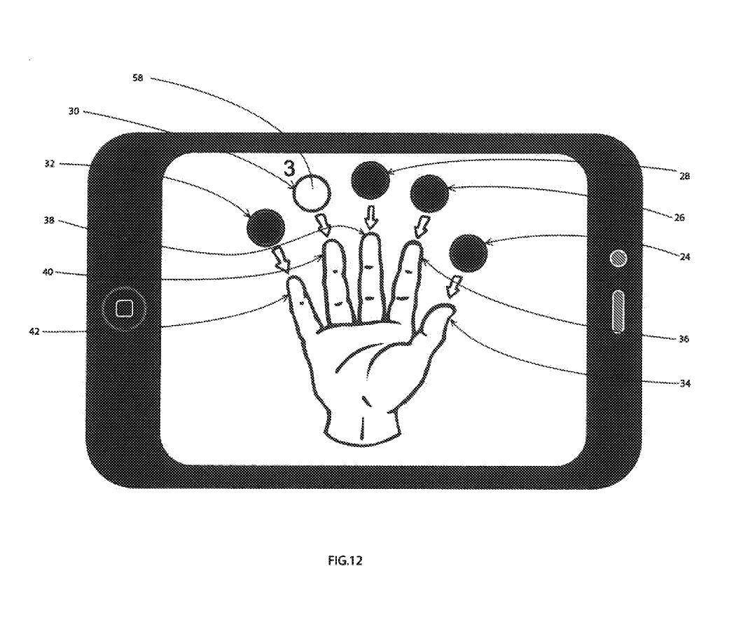

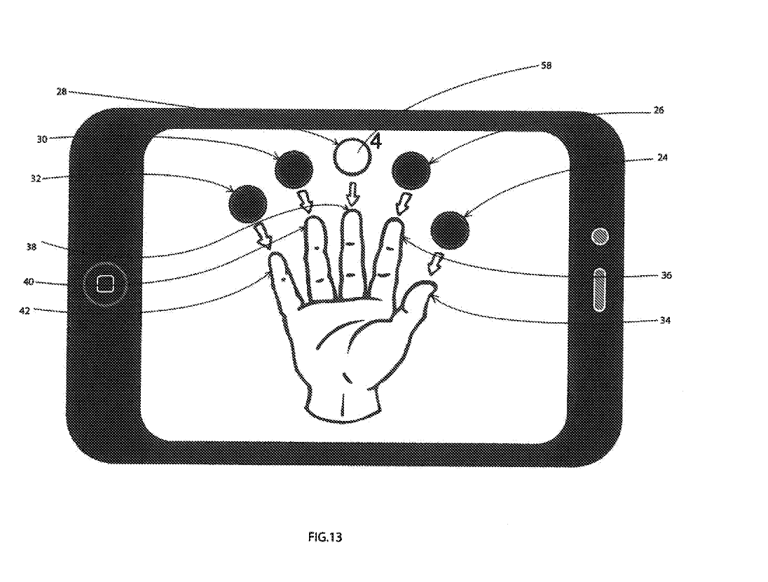

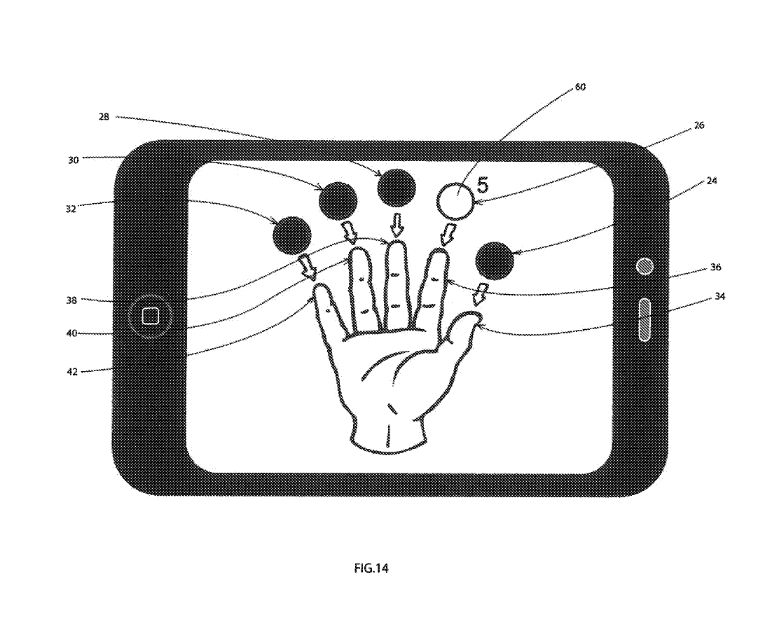

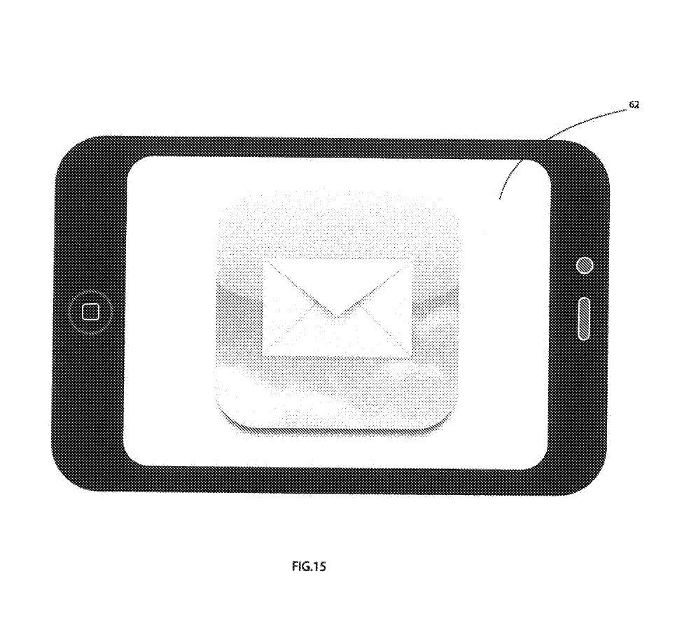

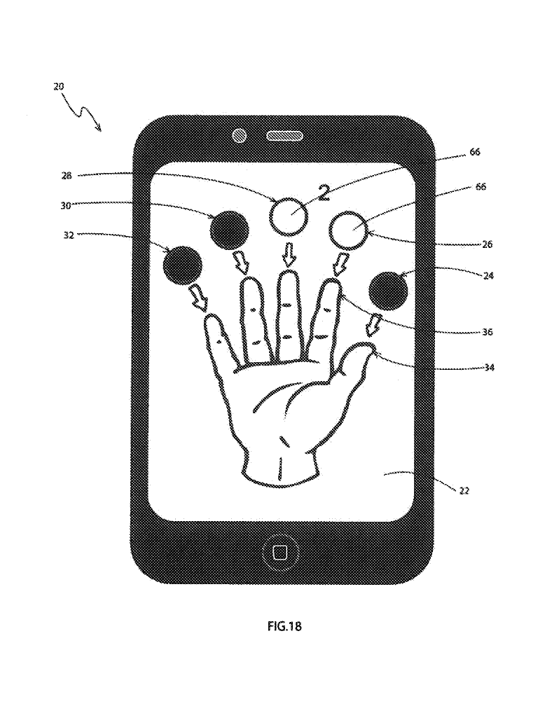

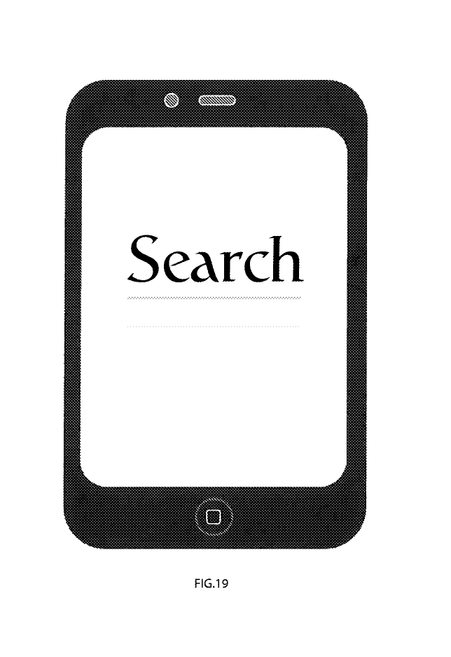

As seen generally in FIGS. 1-19, a multifunction device or computer 20 has a touchscreen display 22. The touch-sensitive touchscreen 22 provides an input interface between the device 20 and a user. A display controller (not shown) receives and/or sends electrical signals from/to the touchscreen 22. Further, touchscreen 22 displays visual output to the user. The visual output may include graphics, text, icons, video, an intentional blank screen, and any combination thereof. Device 20 has a connected power supply.

Touchscreen 22 has a touch-sensitive surface and a sensor or set of sensors that accept input from the user based on haptic and/or tactile contact, also referred to herein as impacting gestures. In an exemplary embodiment, at least one point of contact between the touchscreen 22 and the user corresponds to a finger of the user. Preferably, five points of contact 24, 26, 28, 30, 32 exist between the touchscreen and five fingers of the user respectively. The touchscreen 22, the display controller, and a memory (not shown) are electronically connected together. Together, screen 12, display controller, and memory detect contact and any movement initiating or breaking of the contact on the screen 22 and converts the detected contact into launching an application on device 20. The touchscreen 22 and the display controller may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touchscreen 22. The touchscreen 22 may use LCD (liquid crystal display) technology, or LPD (light emitting polymer display) technology, although other display technologies may be used in other embodiments. A touch-sensitive display in some embodiments of the touchscreen 22 may be analogous to the multi-touch sensitive tablets described in the following U.S. patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1.

An operating system (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. A set of heuristic logic may be programmed in the memory connected to the device. Heuristic logic refers to experience-based techniques for problem solving, learning, and discovery. In the invention, heuristic logic may be used to recognize impacting gestures associated with any one of a user's fingers anywhere on the touchscreen. Heuristic logic may also be programmed to recognize a finger impact or rhythmic pattern without regard to the position of the computer itself.

Pursuant to the above, the device may be programmed to recognize impacting gestures wherein the gestures are recognized when made on any location of the touchscreen 22 and wherein the impacting gestures are recognized when made in any orientation of touchscreen 22. As discussed above, the impacting gestures may be selected from a group comprising one or more taps on touchscreen 22, dragging one or more fingers on touchscreen 22, the timing between sequential touchscreen contact, length of touchscreen contact, and predefined motions made when contacting touchscreen 22. Inasmuch as the device may be programmed to recognize user input or impacting gestures without regard to the location of these impacting gestures on touchscreen 22, and without regard to the orientation of the impacting gestures on touchscreen 22, a user may initiate operations of the device without physically viewing the device. For example, if the device is embodied in a mobile telephone, the user may initiate certain operations while the phone is in a pocket or a duffel bag without having to actually physically view the phone. Thus, the orientation of the phone is inconsequential and the phone can be manipulated where it rests within the user's pocket or duffle bag.

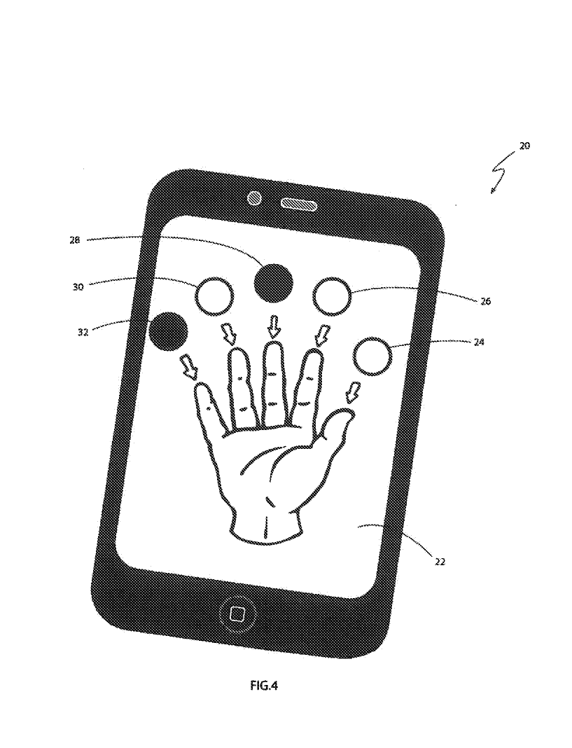

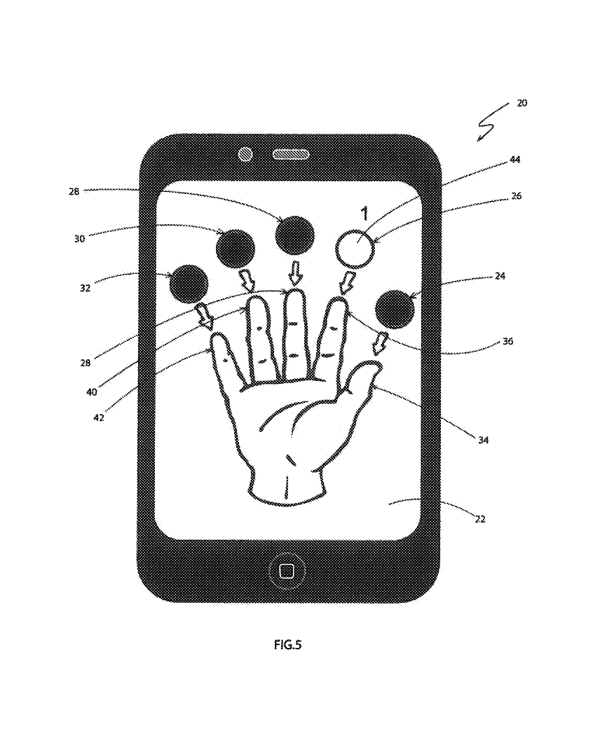

The device is programmed having a set of tap input rules or computer program instructions. The device may be programmed by the user or have a set of pre-programmed tap rules. Tap input rules are stored in the memory and govern the series of tactical gestures contacting the screen 22. Tap input rules are executed by a processor. The tap input rules correspond to the gesture or series of gestures without regard to position or orientation of device 10. Tap input rules recognize the gesture at the point of contact 24, 26, 28, 30, 32 regardless of the angle from vertical, represented by reference numeral alpha a, the screen 22 is oriented as shown in FIGS. 3 and 4. In accordance with the invention, a program application opens and runs by the impacting gesture or series of impacting gestures, not by touching a specific graphic user interface tile or location on the touchscreen. Namely, as shown in FIGS. 3 and 4, the unshaded points of contact 24, 26, 30 indicate an impacting gesture. Whereas the shaded points of contact 28, 32 indicate a non-impacting or approaching gesture. This exemplary embodiment provides a first gesture impacting the touchscreen with a user's thumb, index finger, and ring finger. The user's middle finger and pinky finger do not touch the screen. The heuristic logic programmed in the device cause it to recognize the impacting gesture without regard to the physical vertical alignment or angle from vertical a of the computer. Tap rules of the invention can recognize the absence or release after an impacting gesture.

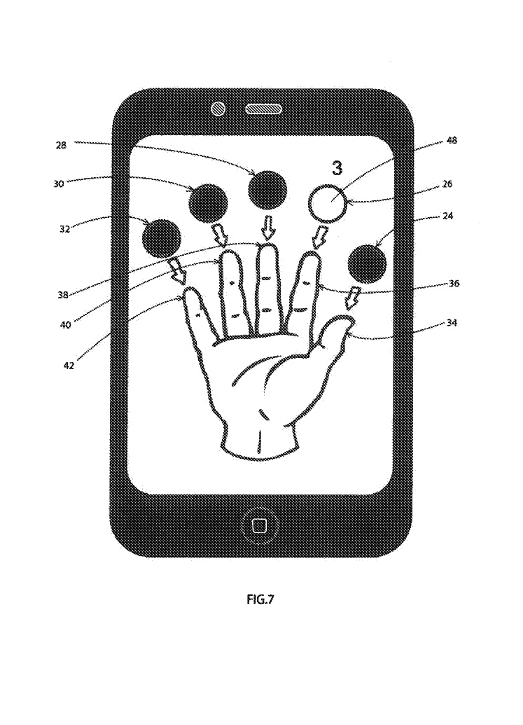

In operation, an application is downloaded via the internet through a portal or app store. The application is initially launched in a set up mode. In set up mode, device 20 is programmed by the user to sense a pattern or rhythm of gestures impacting the screen 22 at the points of contact 24, 26, 28, 30, 32 as shown generally in FIGS. 6-19. A predefined set of functions are performed exclusively through a touchscreen 22 and/or a touchpad include navigation between user interfaces. In some embodiments, the touchpad, when touched by the user, navigates the device 20 to a main, home, or root menu from any user interface that may be displayed on the device 20. In some other embodiments, a menu button may be a physical push button or other physical input/control device instead of a touchpad. The specific impact pattern or rhythm of impacts are assigned to various computer functions. Some exemplary functions include calling a person, opening a calendar, or opening an email.

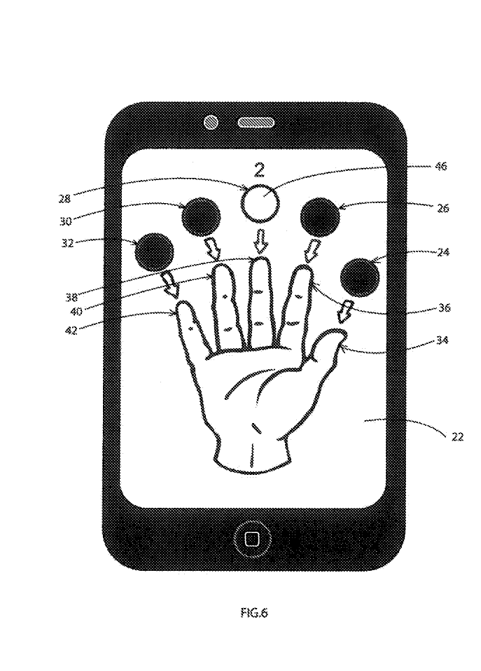

Another embodiment provides a series of impacting gestures shown in FIGS. 5-9. This example shows a device aligned generally vertical programmed to identify a series of impacting gestures to initiate a telephone call. A first gesture 44 impacts the touchscreen at the second contact point 26 (shown unshaded) with an index finger 36. A second gesture 46 impacts the touchscreen 22 at the third contact point 28 (shown unshaded) with the middle finger 38. A third gesture 48 impacts the touchscreen at the second contact point 26 (shown unshaded) with an index finger 36. A fourth gesture 50 impacts the touchscreen 22 at the third contact point 28 (shown unshaded) with the middle finger 38. The set of tap rules recognizes this sequence and the processor electronically executes a telephone function 52.

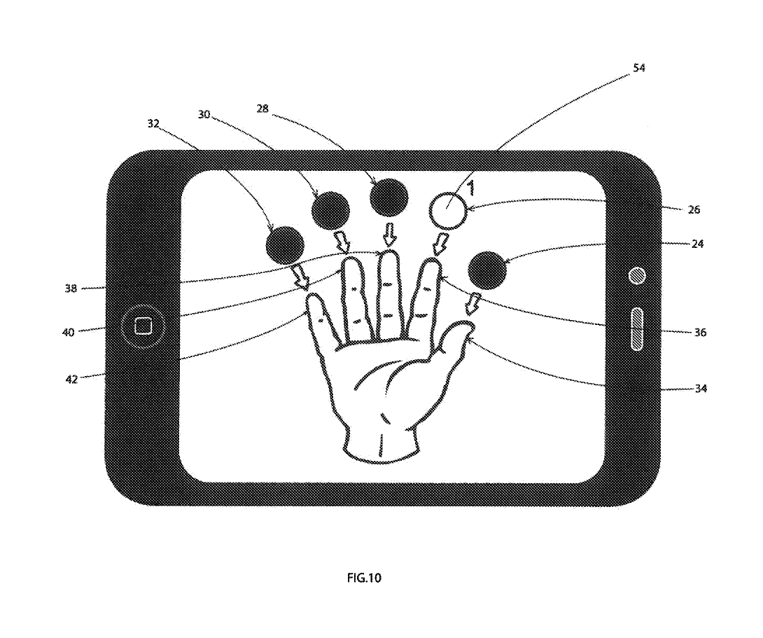

Another embodiment provides a series of impacting gestures shown in FIGS. 10-15. This example shows device 20 oriented generally horizontal programmed to identify the series impacting gestures for opening an electronic mail application. A first gesture 54 impacts the touchscreen 22 at the second contact point 26 (shown unshaded) with an index finger 36. A second gesture 56 impacts the touchscreen 22 at the third contact point 28 (shown unshaded) with the middle finger 38. A third gesture 58 impacts the touchscreen 22 at the fourth contact point 30 (shown unshaded) with the ring finger 40. A fourth gesture 58 impacts the touchscreen 22 at the third contact point 28 (shown unshaded) with the middle finger 38. A fifth gesture 60 impacts the touchscreen at the second contact point 26 (shown unshaded) with an index finger 36. The set of impacting gestures are identified by the tap rules and the processor electronically executes the email application 62.

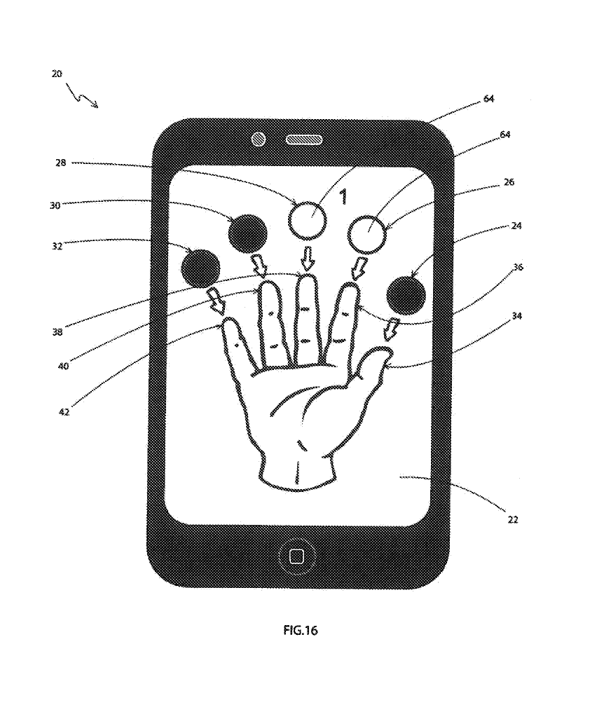

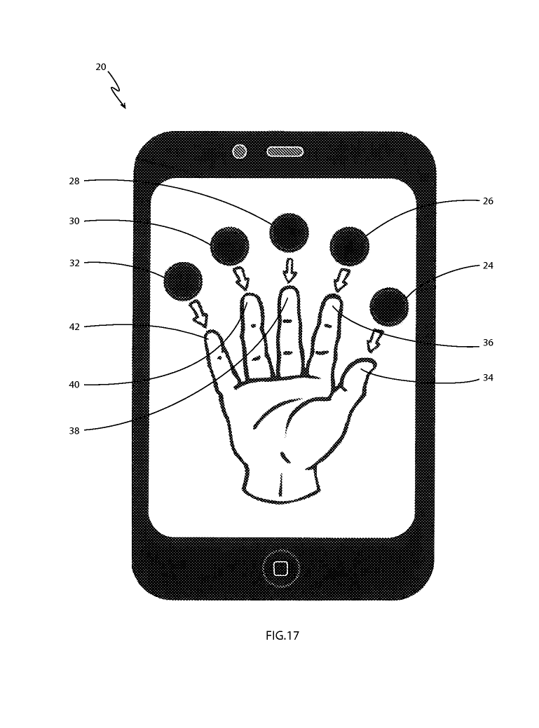

Another embodiment provides a series of impact gestures programmed to open an internet search function shown in FIGS. 16-19. A first gesture 64 impacts the touchscreen 22 at the second contact point 26 (shown unshaded) and the third contact point 38 (shown unshaded) simultaneously with an index finger 36 and middle finger 38 respectively. The device 20 or screen 22 recognizes the presence of a set of fingers. A second gesture approaches but does not impact the touchscreen 22, wherein the contact points are shown shaded in FIG. 17 to indicate the non-impact. A third gesture 66 impacts the touchscreen 22 at the second contact point 26 (shown unshaded) and the third contact point 38 (shown unshaded) simultaneously with an index finger 36 and middle finger 38 respectively. The device 20 and set of tap rules recognize this sequence and the processor electronically executes an internet search function 68.

Alternate embodiments provide engaging the touchscreen in a certain manner so as to initiate a function on device 20. Exemplary embodiments provide physically shaking the device in a randomized manner so an accelerometer can identify the pattern of shaking to initiate a function. Other exemplary embodiments provide impacting the screen through a series of learning taps, wherein the memory of device 20 has the ability to be set by a user. Exemplary embodiments of device 20 learning a series of taps include where a user desires an impact combination series to mimic the beat or musical notes of a song. Further, the application may have smartphone home screen unlocking capabilities.

Impacting gestures such as those described above may be one or more input points from the set of points of contact 24, 26, 28, 30, and/or 32 applied to touch-sensitive display 22. Device 20 may receive a first user input from the set of points of contact 24, 26, 28, 30, and/or 32 and thereafter receive a second user input from the set of points of contact 24, 26, 28, 30, and/or 32. As such, device 20 may calculate a time interval between receiving the first user input and receiving the second user input. Thereafter, device 20 may issue an execution call to execute a particular program or launch an application if the combination of the first user input, second user input, and time interval is associated with the program. As described above, the user may customize device 20 to allow a user of the device to define a gesture combination, wherein the gesture combination is the combination of the first user input, the second user input, and the time interval. The user may then associate a particular gesture combination with a particular program or application of the device. It follows that a user could define a plurality of distinct gesture combinations and associate each gesture combination with a distinct program or application.

Inasmuch as device 20 may calculate time intervals on the micro-second or nano-second level, the underlying software which implements the present invention may determine if the time interval falls within a time range, and certify that the user has satisfied the proper time interval in the gesture combination if the time interval falls within the pre-defined time range. Each gesture combination may be received and recognized by the underlying software in the computing device regardless of the location of the input on the touchscreen and regardless of the orientation of the touchscreen itself. This allows the user to manipulate device 20 with gesture combinations without physically viewing device 20.

The present invention may create an event object in the underlying software in response to the above mentioned first user input, second user input, and/or time interval. The software may then invoke an execute operation in response to a satisfactory combination of event objects. The invention then may issue an execution call based on invoking the execute operation and response to the execution call by executing a program associated with the execution call.

In another embodiment of the present invention, a set of functions executable on device 20 may be defined. Further, a set of gestures recognizable by touchscreen 22 of device 20 may be defined. Thereafter, a first gesture in the set of gestures may be connected to a first function in the set of functions via the underlying software. The first function is then executed when the first gesture is recognized by the touchscreen. The gestures may be a series of physical impacts upon touchscreen 22, such as the previously points of contact 24, 26, 28, 30, and/or 32.

In the foregoing description, certain terms have been used for brevity, clearness, and understanding. No unnecessary limitations are to be implied therefrom beyond the requirement of the prior art because such terms are used for descriptive purposes and are intended to be broadly construed. In other instances, well-known methods, procedures, components, circuits, and networks have not been described in detail so as not to unnecessarily obscure aspects of the embodiments.

It will also be understood that, although the terms first, second, etc. may have been used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used throughout this description is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Moreover, the description and illustration of the preferred embodiment of the invention are an example and the invention is not limited to the exact details shown or described.

1. A method of operating an electronic device having a touchscreen, the method comprising the steps of:
defining a first user input selected from a group comprising: one or more taps on the touchscreen, dragging one or more fingers on the touchscreen, timing between sequential touchscreen contact, length of touchscreen contact, and predefined motions made when contacting the touchscreen;
programming the electronic device to recognize the first user input without regard to the location of the first user input on the touchscreen and without regard to the orientation of the first user input on the touchscreen;
connecting the first user input with an execution call;
initiating an operation of the computing device when the execution call is executed; and
executing the execution call when the first user input is recognized by the computing device.

2. The method of claim 1, further comprising the steps of:
defining a second user input selected from a group comprising: one or more taps on the touchscreen, dragging one or more fingers on the touchscreen, timing between sequential touchscreen contact, length of touchscreen contact, and predefined motions made when contacting the touchscreen;
programming the electronic device to recognize the first user input and the second user input in succession without regard to the location of the second user input on the touchscreen and without regard to the orientation of the second user input on the touchscreen;
connecting the first user input and the second user input in succession with the execution call;
initiating the operation of the computing device when the execution call is executed; and
executing the execution call when the first user input and second user input in succession is recognized by the computing device.

3. The method of claim 2, further comprising:
calculating a time interval between receiving the first user input and receiving the second user input;
connecting the first user input, the time interval, and the second user input in succession with the execution call; and
executing the execution call when the first user input, the time interval, and the second user input in succession is recognized by the computing device.

4. The method of claim 3, further comprising:
allowing a user of the device to define a gesture combination, wherein the gesture combination is the first user input, the time interval, and the second user input in succession; and
allowing the user of the device to associate the gesture combination with the operation.

5. The method of claim 4, further comprising:
allowing the user to define a plurality of gesture combinations, wherein each gesture combination in the plurality of gesture combination is distinct; and
allowing the user to associate each gesture combination with a distinct operation in a plurality of operations of the device.

6. The method of claim 4, wherein the operation is one of an email program, a web browser program, a camera program, a photo viewer program, a contacts program, a phone program, and an instant message program.

7. The method of claim 3, further comprising:
defining a time range; and
programming the electronic device to recognize the time interval when the time interval is within the time range.

8. A method comprising:
receiving a first user input, wherein the first user input is one or more first input points applied to a touch-sensitive display integrated with a computing device;
programming the computing device to recognize the first user input without regard to the location of the one or more first input points on the touch-sensitive display;
programming the computing device to recognize the first user input without regard to the orientation of the one or more first input points on the touch-sensitive display;
creating a first event object in response to the first user input;
determining whether the first event object invokes an execution call; and
responding to the execution call, if issued, by executing a program associated with the execution call.

9. The method of claim 8, further comprising the steps of:
receiving a second user input, wherein the second user input is one or more second input points applied to the touch-sensitive display;
programming the computing device to recognize the second user input without regard to the location of the one or more second input points on the touch-sensitive display;
programming the computing device to recognize the second user input without regard to the orientation of the one or more second input points on the touch-sensitive display;
creating a second event object in response to the second user input;
calculating a time interval between receiving the first user input and receiving the second user input and creating a third event object;
determining whether the combination of the first event object, the second event object, and the third event object invokes an execution call; and
responding to the execution call, if issued, by executing a program associated with the execution call.

10. The method of claim 9, further comprising associating different combinations of event objects with different execution calls.

11. The method of claim 10, further comprising:
defining a plurality of ranges of time;
determining a selected range of time in the plurality of ranges of time, wherein the time interval is within the selected range of time; and
creating the third event object based on the selected range of time.

12. A method comprising the steps of:
defining a set of functions executable on a computing device;
defining a set of gestures recognizable by a touchscreen of the computing device, wherein the gestures are recognized when made on any location of the touchscreen and wherein the gestures are recognized when made in any orientation of the touchscreen; and
connecting a first gesture in the set of gestures with a first function in the set of functions;
executing the first function when the first gesture is recognized by the touchscreen.

13. The method of claim 12, whereby the first gesture is one or more interactions with the touchscreen, each interaction selected from a group comprising: one or more taps on the touchscreen, dragging one or more fingers on the touchscreen, timing between sequential touchscreen contact, length of touchscreen contact, and predefined motions made when contacting the touchscreen.

14. The method of claim 12, whereby the first gesture is a series of physical impacts upon the touchscreen.

15. The method of claim 14, whereby the series of physical impacts are performed by at least two separate fingers on a hand of a user.

16. The method of claim 12, whereby the first gesture is a series of physical impacts upon the touchscreen and a series of time intervals between physical impacts.

17. The method of claim 12, further comprising the steps of:
impacting the touchscreen with a first finger of a user;
waiting a first time interval;
impacting the touchscreen with a second finger of the user; and
whereby the impacting the touchscreen with the first finger, waiting the first time interval, and impacting the touchscreen with the second finger is recognized by the touchscreen as the first gesture.

18. The method of claim 12, further comprising the steps of:
impacting the touchscreen with a first finger of a user;
waiting a first time interval;
impacting the touchscreen with a second finger of the user;
waiting a second time interval;
impacting the touchscreen with a third finger of the user; and
whereby the impacting the touchscreen with the first finger, waiting the first time interval, impacting the touchscreen with the second finger, waiting the second interval, and impacting the touchscreen with the third finger is recognized by the touchscreen as the first gesture.

19. The method of claim 12, further comprising the steps of:
defining a first finger, a second finger, a third finger, a fourth finger, and a fifth finger of a user;
impacting the touchscreen with a first impact, the first impact comprising one of:
the first finger;
the first finger and the second finger simultaneously;
the first finger, the second finger, and the third finger simultaneously;
the first finger, the second finger, the third finger, and the fourth finger simultaneously; and
the first finger, the second finger, the third finger, the fourth finger, and the fifth finger simultaneously;
waiting a first time interval;
impacting the touchscreen with a second impact, the second impact comprising one of:
the first finger;
the first finger and the second finger simultaneously;
the first finger, the second finger, and the third finger simultaneously;
the first finger, the second finger, the third finger, and the fourth finger simultaneously; and
the first finger, the second finger, the third finger, the fourth finger, and the fifth finger simultaneously; and
whereby the impacting the touchscreen with the first impact, waiting the first time interval, and impacting the touchscreen with the second impact is recognized by the touchscreen as the first gesture.

20. The method of claim 12, whereby the first gesture is a physical shaking of the computing device.
